(19) United States
(12) Patent Application Publication
(10) Pub. No.: US 2014/0068908 A1
(43) Pub. Date: Mar. 13, 2014

(54) Threaded Fastening And Repair Device

(71) Applicant: Robert L. Hickey, Charlevoix, MI (US)

(72) Inventor: Robert L. Hickey, Charlevoix, MI (US)

(21) Appl. No.: 14/023,571

(22) Filed: Sep. 11, 2013

Related U.S. Application Data
(60) Provisional application No. 61/699,962, filed on Sep. 12, 2012.

(51) Int. Cl. F16B 19/08; B23P 6/00; B23P 11/00

(52) U.S. Cl. CPC F16B 19/086; B23P 11/00; B23P 6/00
USPC 29/402.19; 428/99; 411/501

(57) ABSTRACT

An apparatus and method for repairing stripped female thread holes in workpieces that form a support for a direct screw connection. A female thread connector is formed from a pop rivet modified with a rotation-preventing outer surface or layer, and installed in the stripped hole with its inner end protruding from the inner side of the support and enlarged into a secondary head in conventional fashion. The rotation-preventing outer surface engages the hole so that a self-tapping screw can be threaded through the connector rivet to make a solid, durable, blind screw connection between an outer workpiece and the support.

### RELATED APPLICATIONS/PRIORITY BENEFIT CLAIM

This application claims the benefit of U.S. Provisional Application No. 61/699,962, filed Sep. 12, 2012 by the same inventor (Hickey), the entirety of which provisional application is hereby incorporated by reference.

### FIELD

The subject matter of the present application is in the field of threaded fasteners, and in particular relates to a device for repairing the female half of a threaded fastener connection in easily stripped materials.

### BACKGROUND

Threaded fasteners such as screws are often used to make direct connections between materials, where the screw is applied directly through a first workpiece to engage a female threaded hole in a second, underlying workpiece or support, without the benefit of a nut at the inner end of the connection. Direct screw connections are common where the fastening is “blind”, i.e. where the person applying the screw from the side of the outermost workpiece cannot see or gain access to the inner side of the screw connection. A good example of a blind connection is an external screw applied to fasten an outer vehicle panel to an inner panel, or to some other underlying support.

“Screw” and “screw connection” are used herein to mean threaded fasteners and fastenings where the fastener is not tightened and secured by a nut on the inner end of the connection, but rather by the frictional engagement between the threads of the fastener and a portion of the workpiece. “Blind” screw connection means a connection where an inner end or side of the connection, behind or inside an underlying screw support, is not easily accessed or viewed by a person making the connection from the outside with a screw.

A common problem with blind screw connections in soft or brittle materials, or in relatively thin-walled workpieces, is the inability of the material to take or hold a durable female thread connection with a male screw. Even if a satisfactory screw connection is made initially, the female portion of the screw connection tends to become stripped over time, due to factors such as vibration and repeated assembly/disassembly. It is not always practical to repair such a stripped screw connection by replacing the underlying support or by using a larger screw.

### BRIEF SUMMARY

I have invented an apparatus and method for repairing stripped blind screw connections in screw supports whose material does not provide a durable female thread, and for making direct screw connections to pre-formed holes or bores in such supports. The apparatus and method may also be used for providing an original female thread connector in the workpiece, rather than for making a repair.

The apparatus comprises a connector in the form of an open-ended rivet whose stem is modified with an outer anti-rotation surface, for example a pressure-activated adhesive or a circumferential series of longitudinal splines or ribs. In the method, the connector rivet is applied to a stripped hole in a support whose material does not lend it to forming or holding a durable female thread. The inner end of the installed rivet is deformed in conventional fashion to form a “secondary head” and protrude from an inner side of the screw support to prevent axial movement of the rivet, and the anti-rotation surface engages the inner sides of the hole through the screw support to prevent the rivet from rotating when a screw is threaded through it.

At least the open bore of the rivet stem is made from a material softer than a mating self-tapping screw, whose thread diameter is larger than the inner diameter of the bore. The screw extends through an outer workpiece mounted over the underlying support, and is self-tapped directly through the installed connector rivet's bore for a direct screw connection.

The method further includes the steps of applying the connector rivet to a stripped hole in a screw support, and securing an outer workpiece to the support via a self-tapping screw applied through the workpiece through the open bore of the rivet.

It is possible to further modify the bore of the rivet with internal female screw threads, so that a non-self-tapping screw can be used for the screw connection.

“Stripped hole” will be used herein to include not only an originally-threaded hole in a support that has been stripped through use, but also an originally non-threaded hole in a support whose material does not lend itself to direct screw connections.

These and other features and advantages of the invention will become apparent from the detailed description below, in light of the accompanying drawings.

### BRIEF DESCRIPTION OF THE DRAWINGS

FIG. 1 is a side elevation view, in partial section, of a connector rivet according to the invention, being applied to a stripped hole in a screw support.

FIG. 2 is similar to FIG. 1, but showing the connector rivet installed in the screw support and showing an outer workpiece and screw exploded from the installed rivet.

FIG. 3 shows the workpiece of FIG. 2 applied to the support, and the screw threaded halfway through the connector.

FIG. 4 is similar to FIG. 3, but with the screw fully threaded through the connector to complete a direct screw connection.

FIG. 5 is similar to FIG. 1, but with the connector rivet modified with an alternate anti-rotation surface comprising splines.

FIG. 6 is similar to FIG. 4, but shows the completed connection using the modified rivet of FIG. 5.

### DETAILED DESCRIPTION

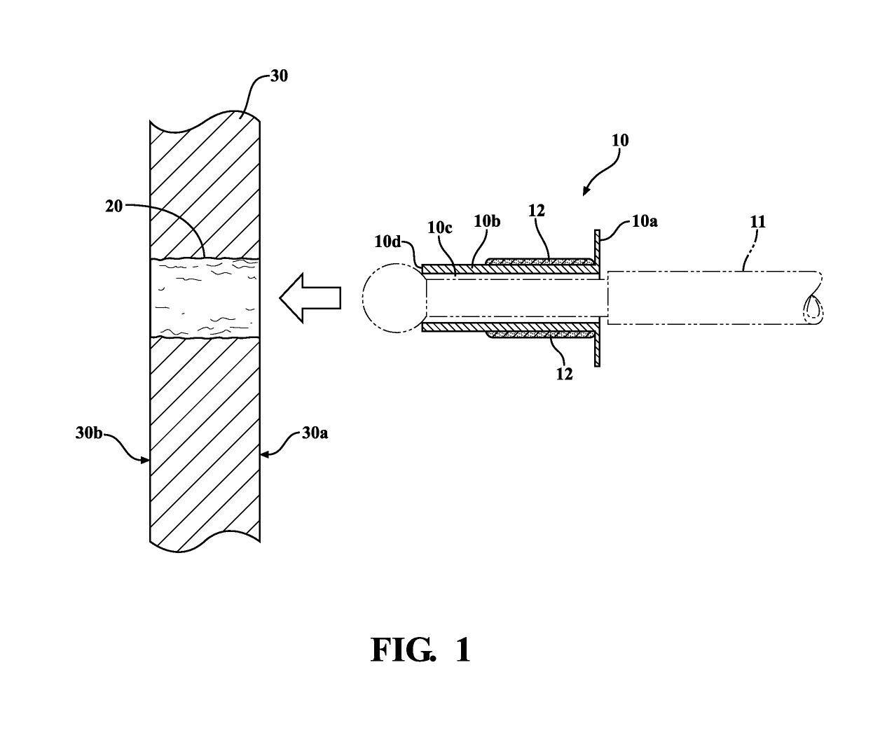

Referring first to FIG. 1, a connector rivet 10 according to one aspect of the invention is shown in exemplary form, in order to teach how to make and use the claimed invention. Illustrated connector 10 includes a standard open-ended pop rivet structure including a head 10a, an open-ended stem 10b with a bore 10c, and an inner end 10d from which the enlarged end of a removable mandrel 11 protrudes. Mandrel 11 is normally supplied with or pre-installed through the bore 10c of the rivet. Mandrel 11 is shown in phantom to reflect the possibility of a rivet-installing tool that might not need a removable mandrel; i.e., a tool with a re-usable mandrel capable of being applied to and removed from multiple rivets to deform their inner ends 10d.

Rivet 10 is modified with a rotation-preventing outer surface 12, in the illustrated example of FIG. 1 with a layer or coating of pressure-activated adhesive over some or all of the rivet stem. It is preferred that a non-tacky, dry or solid, pressure-sensitive or pressure-activated adhesive of known, commercially available type is pre-applied to the rivet stem and/or to the underside of the rivet head. The Loctite® Dri-Loc™ series adhesives (dry-to-the-touch, pre-applied thread locking films) are believed suitable for this purpose. It is also possible to apply a wet coat or layer of adhesive (e.g., regular Loctite® liquid) to the rivet stem just prior to applying the connector rivet 10 to a screw support at the time of repair. Connector rivets with a dry coating or film of pressure-activated adhesive applied to the stem can be stored or sold for later use without the need to apply adhesive to the rivet at the time of repair.

FIG. 1 shows connector rivet 10 being applied to a stripped hole 20 in a screw support 30 whose material does not lend itself to taking or holding a durable female thread. In the illustrated example of FIG. 1, hole 20 represents a hole that originally had a female thread, now damaged or destroyed by repeated disassembly, vibration, or other factors, and no longer capable of holding a screw connection with a male screw. It will be understood that hole 20 could also represent a new, smooth-bored hole in which no screw connection has yet been made.

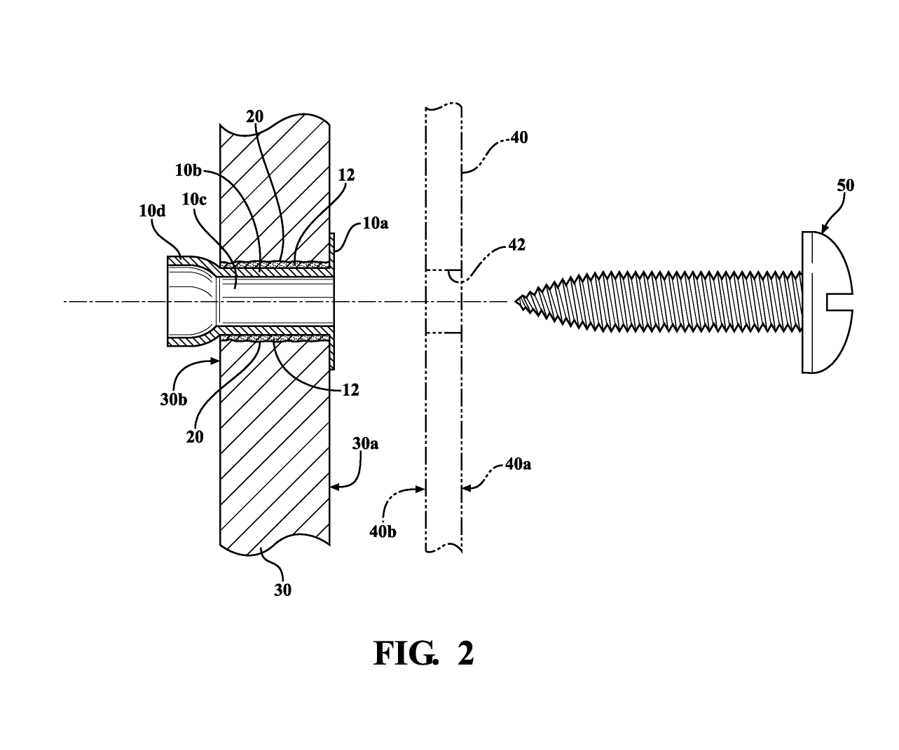

FIG. 2 shows connector rivet 10 installed in hole 20 after mandrel 11 has been removed by a conventional rivet pulling tool (not shown) in conventional fashion to deform inner end 10d into an enlarged secondary head against the inner or “blind” surface 30b of support 30, preventing the rivet from being pulled back out of the hole. Rivet head 10a is preferably flat and thin-walled, so that an outer workpiece such as a panel 40 can fit flush over the installed rivet against the outer surface 30a of support 30. Rounded, domed, and other types of protruding rivet head are possible, but might require that outer workpiece 30 be deformable, or that a recess be made on the underside or inner surface 40b of workpiece 40, in order for workpiece 40 to fit securely against the outer surface of support 30. Non-flat rivet heads may also be used if the inner surface of workpiece 40 over hole 20 is normally spaced with respect to the outer surface of support 30 when attached with a screw.

In FIG. 2, the outer rotation-preventing layer of adhesive 12 is shown activated by the pressure of inserting the rivet into hole 20, deformed and bonding with the inner surface of hole 20 to secure the rivet against rotation. Both permanent and removable adhesives may be used, depending on the desired permanence and strength of the screw connection.

Outer workpiece 40 can be virtually any item capable of being secured by a screw 50 to the underlying support 30. The screw 50 will preferably be installed through a pre-drilled hole 42 in workpiece 40, although depending on the material of workpiece 40 it may also be screwed directly through the material. Screw 50, as noted above, can be any type of screw capable of a direct connection to the material of an underlying support without a nut, including but not limited to sheet metal screws and wood screws. Screw 50 is preferably of the self-tapping type, capable of cutting its own threads in the rivet material, but if rivet 10 is provided with a mating internal thread, a non-self-tapping screw would be possible.

In the illustrated example using a self-tapping screw 50, rivet 10 is made from a softer material such as aluminum, while screw 50 is made from a relatively hard steel. Other combinations of soft and hard materials should be possible, including but not limited to polymers for the rivet body.

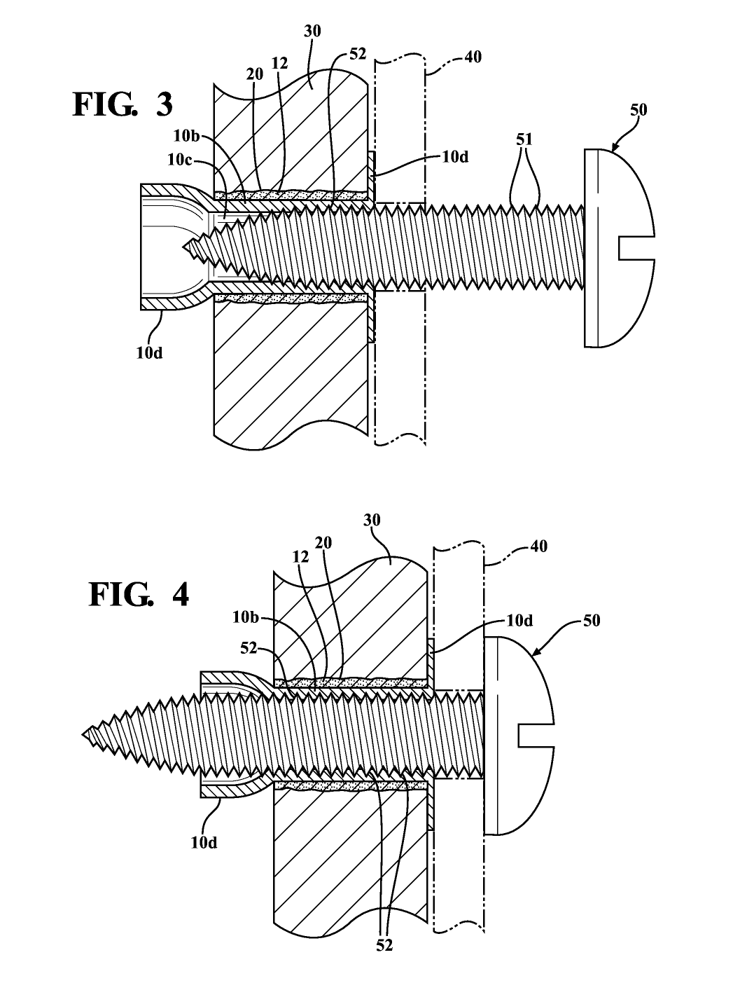

FIG. 3 shows workpiece 40 fitted to the outer face of support 30 over installed connector rivet 10, and screw 50 installed partway through rivet bore 10c, the screw's male threads 51 cutting female threads 52 into the softer material of the connector rivet as it advances.

FIG. 4 shows screw 50 fully installed through connector 10, locking workpiece 40 securely to support 30. It will be understood that threads 52 could also represent a female thread pre-tapped in the bore of connector 10, and sized to mate with the threads on screw 50.

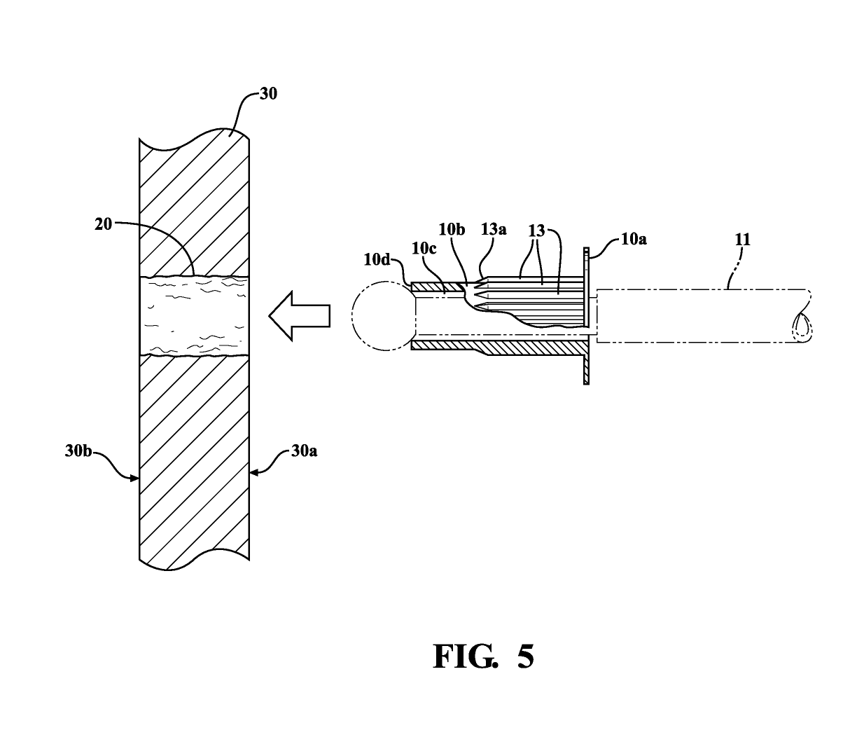

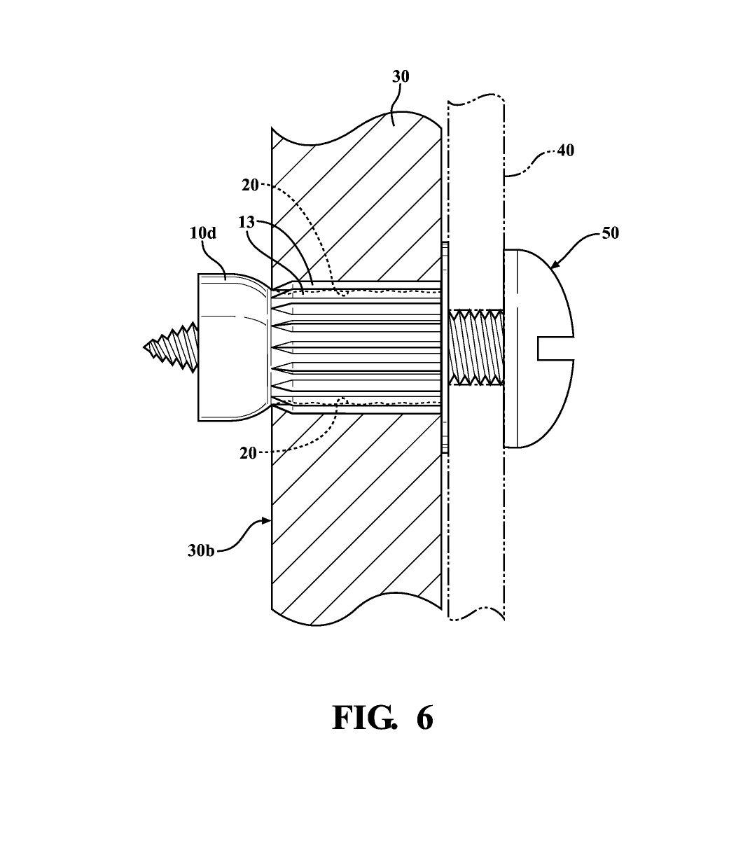

FIGS. 5 and 6 show an alternate rotation-preventing surface on the stem of a connector rivet 10, in the form of longitudinal splines 13 formed around the circumference of the outer surface of rivet stem 10b. While rivet stem 10b has an outer diameter sized to closely match the diameter of hole 20, the outer edges of splines 13 define a diameter greater than the diameter of bore 20, such that the splines cut into or locally displace the support material around hole 20 as the rivet is axially inserted into the hole, thereby engaging the support material surrounding the hole to prevent rotation. Splines 13 are illustrated with leading points or cutting edges 13a to assist this cutting effect, but may not be needed where the material of support 30 is significantly softer than the material of splines 13.

Splines 13 are preferably formed integrally from the material of rivet stem 10b, for example by machining, molding, casting or extruding, but may also be formed separately and then applied to the rivet stem. The number and spacing of splines 13 may vary, they may be continuous or discontinuous along their lengths, and the term “splines” should be understood broadly to include not only long straight fins or ribs, but any generally longitudinal shape that can cut into or locally displace the support material as the rivet is axially inserted into the hole, in order to prevent rotation of the rivet as a screw is threaded through the rivet. For this purpose, splines 13 may also be considered to extend longitudinally inward from the underside of head 10a if they intersect the underside of the head, as shown in the example of FIG. 5.

Splines 13 are shown functioning on their own to prevent rotation, but they may also be supplemented with an adhesive layer or coating 12 such as shown in FIGS. 1-4. Connector rivet 10 in FIGS. 5 and 6 otherwise functions and is used in the same manner as rivet 10 in FIGS. 1 through 4.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been conveniently and widely used to describe new and useful improvements in science and the useful arts. The scope of the invention supported by the above disclosure should accordingly be construed within the scope of what it teaches and suggests to those skilled in the art, and within the scope of any claims that the above disclosure supports in this application or in any other application claiming priority to this application.

What is claimed:

1. An apparatus for repairing a stripped or otherwise non-threaded female thread hole in a screw support whose material does not lend itself to holding or forming a durable female thread, comprising:
a connector rivet comprising a head, a hollow open-ended stem with a deformable inner end, and a rotation-preventing surface on the stem and/or on an underside of the head adapted to engage the material of a screw support around a female thread hole in a screw support.

2. The apparatus of claim 1, wherein the rotation-preventing surface comprises a pressure-activated adhesive.

3. The apparatus of claim 1, wherein the rotation-preventing surface comprises a plurality of longitudinal splines defining a diameter greater than an outer diameter of the rivet stem.

4. The apparatus of claim 3, wherein the longitudinal splines include leading cutting edges.

5. A female thread hole in a screw support whose material does not lend itself to holding or forming a durable female thread, comprising:
a stripped or otherwise non-threaded female thread hole in the screw support; and
a connector rivet comprising a head, a hollow open-ended stem with a deformable inner end, and a rotation-preventing surface on the stem and/or on an underside of the head, the connector rivet installed in the female thread hole with the head engaging an outer surface of the screw support and with the inner end protruding from an inner surface of the screw support and deformed into an enlarged secondary head against the inner surface of the screw support, and with the rotation-preventing outer surface in rotation-preventing contact with the material of the screw support around the hole.

6. The female thread hole of claim 5, wherein the rotation-preventing surface comprises a pressure-activated adhesive.

7. The female thread hole of claim 6, wherein the pressure-activated adhesive is on an outer surface of the stem and is in adhesive contact with the material of the screw support defining an inner surface of the hole.

8. The female thread hole of claim 6, wherein the rotation-preventing surface comprises a plurality of longitudinal splines defining a diameter greater than an outer diameter of the rivet stem and greater than an inner diameter of the female thread hole, the splines extending into the material of the screw support around the hole.

9. A method for repairing a stripped female thread hole in a screw support whose material does not lend itself to holding or forming a durable female thread, comprising:
installing a connector rivet in a stripped or otherwise non-threaded female thread hole in a screw support from an outer surface of the screw support, the connector rivet comprising a head, a hollow open-ended stem with a deformable inner end, and a rotation-preventing surface on the stem and/or an underside of the head, such that the inner end of the rivet protrudes from an inner surface of the screw support and is deformed into an enlarged secondary head against the inner surface, and such that the rotation-preventing surface is in rotation-preventing contact with material of the screw support around the female thread hole.

10. The method of claim 6, further including applying a workpiece over the repaired female thread hole, and inserting a self-tapping screw through the workpiece and threading the screw through the bore of the installed connector rivet to secure the workpiece to the support.
